(19) United States
(12) Patent Application Publication
(10) Pub. No.: US 2024/0301569 A1
(43) Pub. Date: Sep. 12, 2024

(54) DIRECT CONVERSION OF AIR TO AMMONIA VIA ADVANCED MANUFACTURED ELECTROCHEMICAL REACTORS

(71) Applicant: Lawrence Livermore National Security, LLC, Livermore, CA (US)

(72) Inventors: Jeremy Taylor Feaster, Fremont, CA (US); Roger Aines, Livermore, CA (US); Sneha Anil Akhade, Oakland, CA (US); Sarah Baker, Dublin, CA (US); Patrick Campbell, Oakland, CA (US); Maira Ceron Hernandez, Brentwood, CA (US); Jonathan Tesner Davis, Oakland, CA (US); Eric Duoss, Dublin, CA (US)

(21) Appl. No.: 18/667,931

(22) Filed: May 17, 2024

Related U.S. Application Data
(63) Continuation-in-part of application No. 18/052,310, filed on Nov. 3, 2022.
(60) Provisional application No. 63/263,520, filed on Nov. 4, 2021.

(51) Int. Cl. C25B 9/21; C05C 3/00; C05C 5/00; C25B 1/27; C25B 9/60; C25B 15/08

(52) U.S. Cl. CPC C25B 9/21; C05C 3/00; C05C 5/00; C25B 1/27; C25B 9/60; C25B 15/081

(57) ABSTRACT

An advanced manufactured electrochemical reactor to convert air (N₂+O₂) to nitric acid (HNO³) and ammonia (NH₃). The electrochemical reactor platform can be tailored via advanced manufacturing to improve activity, selectivity, energy efficiency and stability of the reactions.

### RELATED APPLICATIONS

This application is a Continuation-in-Part of U.S. application Ser. No. 18/052,310 filed Nov. 3, 2022, and claims priority to U.S. Provisional Patent Application No. 63/263,520 filed Nov. 4, 2021, both of which are herein incorporated by reference.

This invention was made with Government support under Contract No. DE-AC52-07NA27344 awarded by the United States Department of Energy. The Government has certain rights in the invention.

### FIELD OF THE INVENTION

The present invention relates to converting air to ammonia and nitric acid, and more particularly, this invention relates to direct conversion of air to ammonia and nitric acid using advanced manufactured electrochemical reactors.

### BACKGROUND

Over 3.5 billion people—almost half of the world's population—depend on food and crops grown with the help of synthetic nitrogen fertilizers. The industrial production of ammonia (NH₃) and nitric acid (HNO₃), the two key ingredients for creating nitrogen fertilizers, is made possible via the Haber-Bosch and Ostwald processes, respectively, as shown in part (a) of FIG. 1. However, these approaches are energy and resource intensive. Together these processes consume over 2% of the world's total energy and 5% of the world's annual natural gas production. Consequently, these key processes also contribute over 1.5% of the world's total greenhouse gas emissions, i.e., large production of carbon waste. Furthermore, both the Ostwald and Haber-Bosch processes require high pressures and temperatures to operate; additionally, energy-intensive separation processes must be employed to ensure pure reactant feedstocks and eliminate unwanted side reactions. It is paramount to discover and develop alternative pathways to produce HNO₃ and NH₃ in an energy-efficient, environmentally sustainable, and industrially scalable manner.

Electrochemical synthesis and catalytic transformations are a promising approach for synthesis of HNO₃ and NH₃ at room temperature and ambient pressures. There has been increased interest in pursuing electrocatalytic reduction of N₂ to NH₃ (nitrogen reduction reaction, NRR), as shown in part (b) of FIG. 1. While some progress has been achieved, this pathway still requires an energy-costly separation of N₂ from air. Furthermore, the competing hydrogen evolution reaction (HER) often results in low selectivity for NH₃ in aqueous electrolytes. Moreover, electrochemical NH₃ production is difficult because the stability of N₂.

Alternatively, a direct nitridation of N₂ using Li metal has been shown to be a molten salt nitridation approach to producing NH₃ with decent selectivity as shown in part (c) of FIG. 1; however, this pathway requires electrolysis in molten salts, which has a nontrivial separation cost and high energy consumption. Moreover, the reaction is difficult because the negatively charged reactant is at the cathode.

Essentially all electrochemical efforts to convert N₂ into NH₃ have been focused on reduction reactions of nitrogen on the cathode with the oxygen evolution reaction (OER) typically performed on the anode. Almost no research has been conducted on any electrochemical oxidation reactions involving nitrogen.

### SUMMARY

Features and advantages of the disclosed apparatus, systems, and methods will become apparent from the following description. Applicant is providing this description, which includes drawings and examples of specific embodiments, to give a broad representation of the apparatus, systems, and methods. Various changes and modifications within the spirit and scope of the application will become apparent to those skilled in the art from this description and by practice of the apparatus, systems, and methods. The scope of the apparatus, systems, and methods is not intended to be limited to the particular forms disclosed and the application covers all modifications, equivalents, and alternatives falling within the spirit and scope of the apparatus, systems, and methods as defined by the claims.

According to one embodiment, an apparatus for converting air to ammonia includes an anode gas compartment for receiving air, an anode electrocatalyst coupled to the anode gas compartment, a cathode gas compartment, and a cathode electrocatalyst coupled to the cathode gas compartment. The apparatus further includes an electrolyte compartment having a liquid electrolyte, where the electrolyte compartment is positioned between the anode electrocatalyst and the cathode electrocatalyst. The anode electrocatalyst is operably configured to convert nitrogen from the air to nitrate at the anode electrocatalyst. The cathode electrocatalyst is operably configured to convert the nitrate to the ammonia at the cathode electrocatalyst.

According to another embodiment, a method of converting a feed gas to a reduced product includes providing an electrochemical reactor. The electrochemical reactor includes an anode gas compartment, an anode electrocatalyst coupled to the anode gas compartment, a cathode gas compartment, and a cathode electrocatalyst coupled to the cathode gas compartment. The electrochemical reactor also includes an electrolyte compartment including a liquid electrolyte, where the electrolyte compartment is positioned between the anode electrocatalyst and the cathode electrocatalyst. The method includes directing the feed gas through the anode gas compartment to the anode electrocatalyst to convert one or more components of the feed gas to an intermediate in the liquid electrolyte, and directing a sweep gas through the cathode gas compartment to convert the intermediate in the liquid electrolyte to the reduced product.

Applicant's apparatus, systems, and methods provide an advanced manufactured electrochemical reactor to convert air (N₂+O₂) to nitric acid (HNO₃) ammonia (NH₃). The electrochemical reactor platform can be tailored via advanced manufacturing to improve activity, selectivity, energy efficiency and stability of the reactions.

The apparatus, systems, and methods are susceptible to modifications and alternative forms. Specific embodiments are shown by way of example. It is to be understood that the apparatus, systems, and methods are not limited to the particular forms disclosed. The apparatus, systems, and methods cover all modifications, equivalents, and alternatives falling within the spirit and scope of the application as defined by the claims.

Other aspects and advantages of the present invention will become apparent from the following detailed description, which, when taken in conjunction with the drawings, illustrate by way of example the principles of the invention.

### BRIEF DESCRIPTION OF THE DRAWINGS

The accompanying drawings, which are incorporated into and constitute a part of the specification, illustrate specific embodiments of the apparatus, systems, and methods and, together with the general description given above, and the detailed description of the specific embodiments, serves to explain the principles of the apparatus, systems, and methods.

FIG. 1 illustrates schematic diagrams of conventional approaches to production of ammonia. Part (a) Haber-Bosch and Ostwald process, part (b) electrochemical synthesis, and part (c) electrolysis in molten salts.

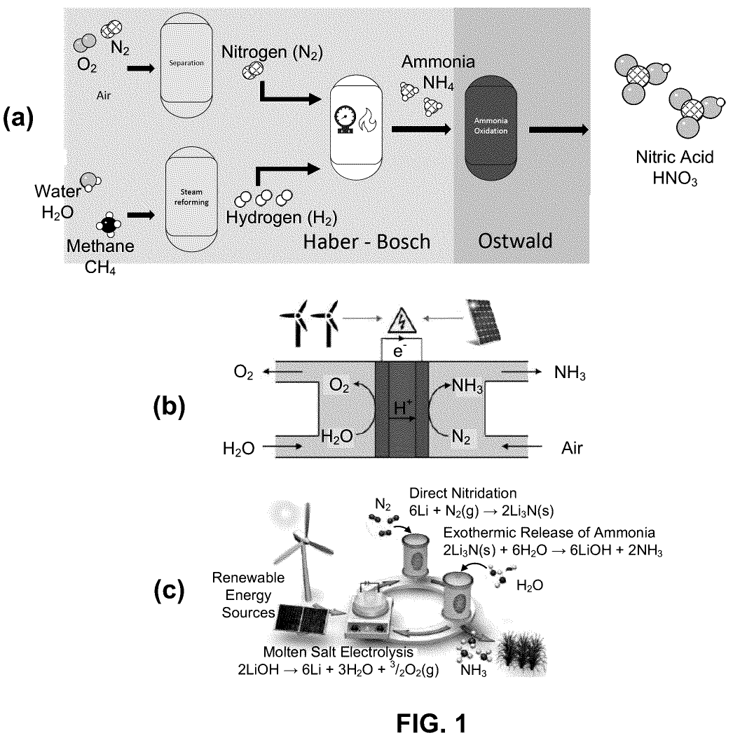

FIG. 2 illustrates a schematic diagram of a direct air to ammonia process, according to one embodiment. Part (a) system of converting air to ammonia, part (b) electrochemical cell.

FIG. 3 is an operative view of an electrochemical cell and system, according to one embodiment.

FIG. 4 is a schematic drawing of an electrochemical cell and methods to assess formed products, according to one embodiment.

FIG. 5 is a flowchart of an additive manufacturing system of producing a reactor for converting air to ammonia, according to one embodiment.

FIG. 6 is a method of converting a feed gas to a reduced product using an electrochemical reactor, according to one embodiment.

FIG. 7 illustrates possible nitrogen-based products formed at the anode by a nitrogen oxidation reaction, according to one embodiment.

FIG. 8 is a schematic drawing of the rate limiting steps for nitrogen oxidation reactions on the anode, according to one embodiment.

FIG. 9 depicts the effect of electrolyte on the total current of the reactor, according to one embodiment. Part (a) is a plot of different electrolytes, and part (b) is a plot of different input gases in a reactor having potassium carbonate electrolyte.

FIG. 10 depicts outcomes of preliminary experiments of a reactor having N₂ gas or CO₂ as input gas, according to one embodiment. Part (a) is a plot depicting the total current of the system, and part (b) is a graph of UV absorption of bicarbonate and nitrate.

FIG. 11 depicts the results of a reactor using 3M carbonate electrolyte, according to one embodiment. Part (a) is a plot of input gas being Ar or N2 flow and products formed at different applied potentials, part (b) is a plot of nitrate produced using ion chromatography.

FIG. 12 depicts plots of detection of products formed at the anode in a reactor, according to one embodiment. Part (a) a plot of NO detected by mass spectrometry, part (b) is a plot of NO₃⁻ detected by NMR.

FIG. 13 is a plot of NO₃⁻ partial current in terms of applied potential for NO₃⁻ formed by commercial processes and NO₃⁻ formed by an apparatus and system described herein, according to one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

For the purposes of this application, room temperature is defined as in a range of about 20° C. to about 25° C. Atmospheric pressure is defined in terms of Atmosphere (ATM), a unit of measurement equal to the average air pressure at sea level at a temperature of 15° C. In terms of ambient conditions, the atmospheric pressure drops as altitude increases.

As also used herein, the term “about” denotes an interval of accuracy that ensures the technical effect of the feature in question. In various approaches, the term “about” when combined with a value, refers to plus and minus 10% of the reference value. For example, a thickness of about 10 nm refers to a thickness of 10 nm±1 nm, a temperature of about 50° C. refers to a temperature of 50° C.±5° C., etc.

A nanoscale, nanoporous, etc. is defined as having a diameter or length (e.g., a pore having an average diameter) less than 1000 nanometers (nm). A microscale, microporous, micron-sized, etc. is defined as having a diameter or length (e.g., a pore having an average diameter) less than about 1000 microns (μm).

It is also noted that, as used in the specification and the appended claims, wt. % is defined as the percentage of weight of a particular component relative to the total weight/mass of the mixture. Vol. % is defined as the percentage of volume of a particular compound relative to the total volume of the mixture or compound. Mol. % is defined as the percentage of moles of a particular component relative to the total moles of the mixture or compound. Atomic % (at. %) is defined as a percentage of one type of atom relative to the total number of atoms of a compound.

Unless expressly defined otherwise herein, each component listed in a particular approach may be present in an effective amount. An effective amount of a component means that enough of the component is present to result in a discernable change in a target characteristic of the ink, printed structure, and/or final product in which the component is present, and preferably results in a change of the characteristic to within a desired range. One skilled in the art, now armed with the teachings herein, would be able to readily determine an effective amount of a particular component without having to resort to undue experimentation.

The following description discloses several preferred for direct conversion of air to ammonia and nitric acid and/or related systems and methods.

In one general embodiment, an apparatus for converting air to ammonia includes an anode gas compartment for receiving air, an anode electrocatalyst coupled to the anode gas compartment, a cathode gas compartment, and a cathode electrocatalyst coupled to the cathode gas compartment. The apparatus further includes an electrolyte compartment having a liquid electrolyte, where the electrolyte compartment is positioned between the anode electrocatalyst and the cathode electrocatalyst. The anode electrocatalyst is operably configured to convert nitrogen from the air to nitrate at the anode electrocatalyst. The cathode electrocatalyst is operably configured to convert the nitrate to the ammonia at the cathode electrocatalyst.

In another general embodiment, a method of converting a feed gas to a reduced product includes providing an electrochemical reactor. The electrochemical reactor includes an anode gas compartment, an anode electrocatalyst coupled to the anode gas compartment, a cathode gas compartment, and a cathode electrocatalyst coupled to the cathode gas compartment. The electrochemical reactor also includes an electrolyte compartment including a liquid electrolyte, where the electrolyte compartment is positioned between the anode electrocatalyst and the cathode electrocatalyst. The method includes directing the feed gas through the anode gas compartment to the anode electrocatalyst to convert one or more components of the feed gas to an intermediate in the liquid electrolyte, and directing a sweep gas through the cathode gas compartment to convert the intermediate in the liquid electrolyte to the reduced product.

A list of acronyms used in the description is provided below.
2D two-dimensional
3D three-dimensional
ATM atmosphere
CAD computer aided design
C Celsius
HER hydrogen evolution reaction
HNO₃ nitric acid
ms millisecond
nm nanometer
N₂ nitrogen gas
N₂O nitrous oxide
NH₃ ammonia
NO₃-nitrate
NO₃RR nitrate reduction reaction
NOR nitrogen oxidation reaction
NRR nitrogen reduction reaction
OER oxygen evolution reaction
PV photovoltaic
RHE reversible hydrogen electrode
sccm standard cubic centimeters
SHE standard hydrogen electrode
μm micron
wt % weight percent

Referring to the drawings, to the following detailed description, and to incorporated materials, detailed information about the apparatus, systems, and methods is provided including the description of specific embodiments. The detailed description serves to explain the principles of the apparatus, systems, and methods. The apparatus, systems, and methods are susceptible to modifications and alternative forms. The application is not limited to the particular forms disclosed. The application covers all modifications, equivalents, and alternatives falling within the spirit and scope of the apparatus, systems, and methods as defined by the claims.

Preferred approaches for making ammonia minimize a dependence on carbon. According to one embodiment, ammonia is formed using air, water, and sustainable electricity (sun) using a reactor. As described herein, according to one approach, an electrochemical reactor has a vapor-fed architecture, higher N₂ solubility, and higher gas diffusivity. The advantages include 1) ammonia may be formed in any environment, e.g., the environment of air intake, such as room temperature, 1 ATM, etc., 2) using air directly removes requirement to separate nitrogen from oxygen, and having to use pure sources of nitrogen, and, 3) one product is formed without generation of side products.

According to one embodiment, an apparatus converts air (O₂ and N₂) input on an anode side, i.e., the positively charged electrode, and passed through a porous electrode to an electrolyte that functions also as a separator between the gaseous feed (e.g., air) and gaseous reactant to form a liquid or aqueous product, such as nitrate. The formed nitrate is transported to the cathode, i.e., the negatively charged electrode, where the nitrate is reduced to ammonia. Both of the electrodes are working together to produce just ammonia.

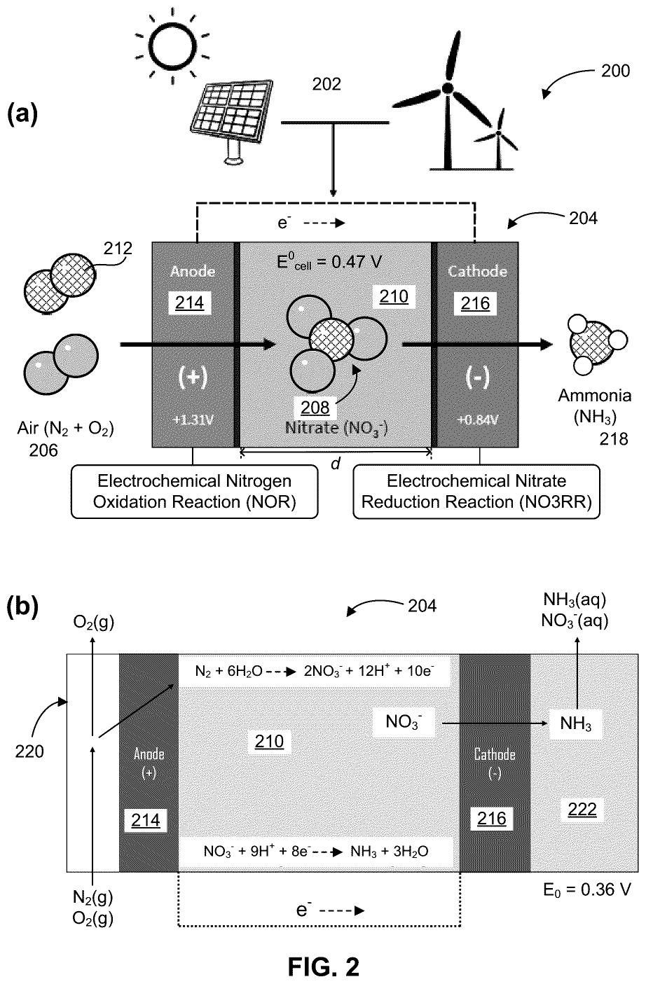

FIG. 2 depicts a schematic diagram of a system 200, in accordance with one aspect of an inventive concept. As an option, the present system 200 may be implemented in conjunction with features from any other inventive concept listed herein, such as those described with reference to the other FIGS. Of course, however, such a system 200 and others presented herein may be used in various applications and/or in permutations which may or may not be specifically described in the illustrative embodiments listed herein. Further, the system 200 presented herein may be used in any desired environment.

According to one embodiment, a system is described for converting air to ammonia. FIG. 2 illustrates a series of schematic drawings of converting direct air to ammonia process using renewable energy. As illustrated in the part (a) of FIG. 2, a system 200 incudes renewable energy 202 may be used to power an advanced manufactured electrochemical reactor 204 that converts air 206 (N₂+O₂, e.g., in a gas having said elements, such as ambient air from the Earth's atmosphere) to nitrate 208 (NO₃⁻) and ammonia 218 (NH₃). Renewable energy 202 is energy that has been derived from earth's natural resources that are not finite or exhaustible, such as wind and sunlight. Solar energy is derived by capturing radiant energy from sunlight and converting it into heat, electricity, or hot water. Photovoltaic (PV) systems can convert direct sunlight into electricity through the use of solar cells. Wind farms capture the energy of wind flow by using turbines and converting it into electricity. There are several forms of systems used to convert wind energy and each vary. Commercial grade wind-powered generating systems can power many different organizations, while single-wind turbines are used to help supplement pre-existing energy organizations. Another form is utility-scale wind farms, which are purchased by contract or wholesale. Technically, wind energy is a form of solar energy. The ocean can produce two types of energy: thermal and mechanical.

Ocean thermal energy relies on warm water surface temperatures to generate energy through a variety of different systems. Using the reactor 204 in FIG. 2, N₂ 212 is oxidized to nitrate 208 at the anode 214, then reduced to ammonia 218 at the cathode 216. Other reactions can be performed at the cathode 216. The anode 214 facilitates an electrochemical nitrogen oxidation reaction (NOR) to convert the N₂ 212 to nitrate 208. The cathode 216 facilitates an electrochemical nitrate reduction reaction (NO₃RR) to convert nitrate 208 to ammonia 218.

Part (b) of FIG. 2 illustrates an example of chemical reactions that may occur in the electrochemical reactor 204 that includes an anode gas compartment 220 that passes air (N₂, O₂) therethrough allowing nitrogen to react at the anode 214. A reaction of N₂ with water (H₂O) results in nitrate in the electrolyte 210. At the cathode 216 a reduction reaction of nitrate may result in ammonia NH₃ 218, and the ammonia is released in the cathode gas compartment 222.

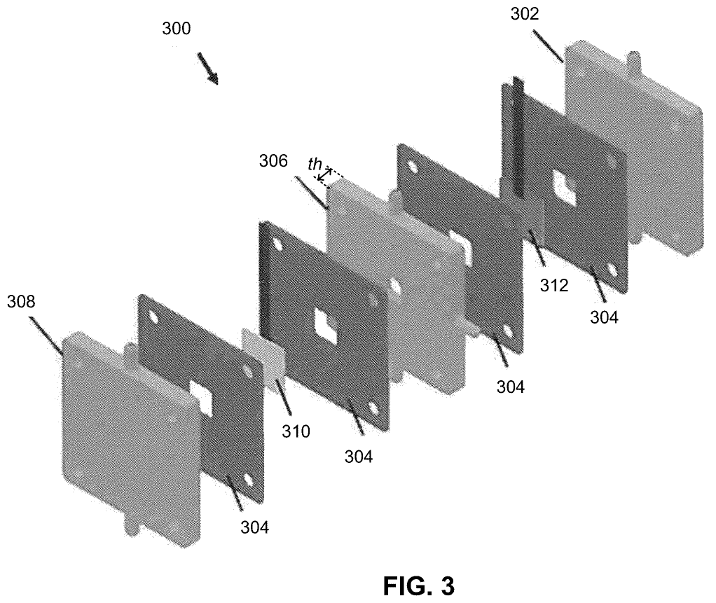

Referring now to the drawings and in particular to FIG. 3, an illustrative view shows one embodiment of an apparatus, systems, and methods. This embodiment is an advanced manufactured electrochemical reactor 300 that converts air (N₂+O₂) to nitric acid (HNO₃) and ammonia (NH₃). In one approach, the reactor converts air at the anode to nitrate in the electrolyte, and then at the cathode water is split to form hydrogen (H₂). The nitrate is then later reduced to ammonia in a separate reactor.

FIG. 3 illustrates an advanced manufactured electrochemical reactor 300 that converts air (N₂+O₂) to nitric acid (HNO₃) and ammonia (NH₃). The reactor 300 has three main compartments: an anode gas compartment 308, an electrolyte compartment 306, and a cathode gas compartment 302. Gaskets 304 may be positioned between the compartments. In some approaches, the gaskets 304 may be silicone gaskets.

The anode gas compartment 308 includes an anode electrocatalyst 310. In one approach, the anode electrocatalyst 310 may be positioned adjacent the anode gas compartment 308. In another approach, the anode electrocatalyst 310 may be a portion of the structure of the anode gas compartment 308. The anode electrocatalyst 310 (e.g., the anode) may be disposed between the anode gas compartment 308 and the electrolyte compartment 306.

In one approach, the anode gas compartment 308 may be left open to air. The air may be a combination primarily of O₂ and N₂ and include impurities. In another approach, the anode gas compartment may be fed a gas of N₂ and O₂ in a comparable composition as air. For example, the anode compartment 308 may be sealed with a compressed gas (e.g., N₂, Ar, CO₂) flowing. The anode gas compartment 308 provides an inlet for N₂ to the reactor 300. The anode design includes an anode gas compartment and an anode electrocatalyst that allows N₂ gas to quickly diffuse and reach the electrocatalysts interface at higher concentrations.

The structure of the anode electrocatalyst 310 is porous. Preferably, the anode electrocatalyst is characterized as having a high surface area to increase the number of active sites. The structure of the anode electrocatalyst 310 may have a thickness of a thin structure, for example, having a thickness in a range of about 50 μm (e.g., a thickness of a piece of paper) to 1 mm (thickness of a penny). The anode preferably has a catalyst deposited on the porous anode structure. In some approaches, the catalyst is an electrocatalyst. The anode electrocatalyst 310 is operably configured to convert nitrogen from the air to nitrate at the anode electrocatalyst 310. In some approaches, the anode electrocatalyst includes one of the following electrocatalysts: platinum (Pt), titanium (Ti), iridium (Ir), nickel (Ni), iron (Fe), ruthenium (Ru), palladium (Pd), tin (Sn), and gallium (Ga).

The cathode gas compartment 302 includes a cathode electrocatalyst 312. The cathode electrocatalyst 312 may be coupled to the cathode gas compartment 302. In one approach, the cathode electrocatalyst 312 may be positioned adjacent the cathode gas compartment 302. In another approach, the cathode electrocatalyst 312 may be a portion of the structure of the cathode gas compartment 302. The cathode electrocatalyst 312 may be disposed between the cathode gas compartment 302 and the electrolyte compartment 306.

The cathode gas compartment includes a flowing gas stream connected to the cathode gas compartment. The flowing gas stream may include an inert gas. The cathode design of the cathode electrocatalyst and the cathode gas compartment produces hydrogen gas (H₂) that is removed from the reactor thereby preventing buildup of hydrogen gas inside the reactor.

The cathode electrocatalyst 312 structure is porous. The structure of the cathode electrocatalyst 312 may have a thickness of a thin structure, for example, having a thickness in a range of 50 μm (e.g., a thickness of a piece of paper) to 1 mm (thickness of a penny). The cathode preferably has a catalyst deposited on the porous cathode structure. The cathode In some approaches, the catalyst is an electrocatalyst. The cathode electrocatalyst 312 is operably configured to convert nitrate to ammonia at the cathode electrocatalyst 312. In some approaches, the cathode electrocatalyst includes one of the following electrocatalysts: silver (Ag), gold (Au), copper (Cu), platinum (Pt), titanium (Ti), iridium (Ir), nickel (Ni), Iron (Fe), and tin (Sn).

The reactor includes an electrolyte compartment 306 that may be positioned between the anode electrocatalyst 310 and the cathode electrocatalyst 312. The electrolyte compartment 306 is preferably a liquid electrolyte compartment. The electrolyte compartment 306 does not include a membrane. The reactor may not include a membrane component. The electrolyte compartment 306 functions as a separation between the anode gas compartment 308 and the cathode gas compartment 302 of the reactor 300. The volume of electrolyte is related to the distance between the two electrodes. In preferred approaches, a low volume (e.g., in a range of about 1 to 15 mls, and preferably about 5 to 15 mls) of electrolyte (with flow) increases nitrate (NO₃) detection sensitivity. The electrolyte compartment may be tailored to have a thickness in a range of 15 mm to about 1 mm, preferably in a range of 7 mm to about 1 mm. In one approach, the thickness th correlates with a distance d between the anode electrocatalyst and the cathode electrocatalyst.

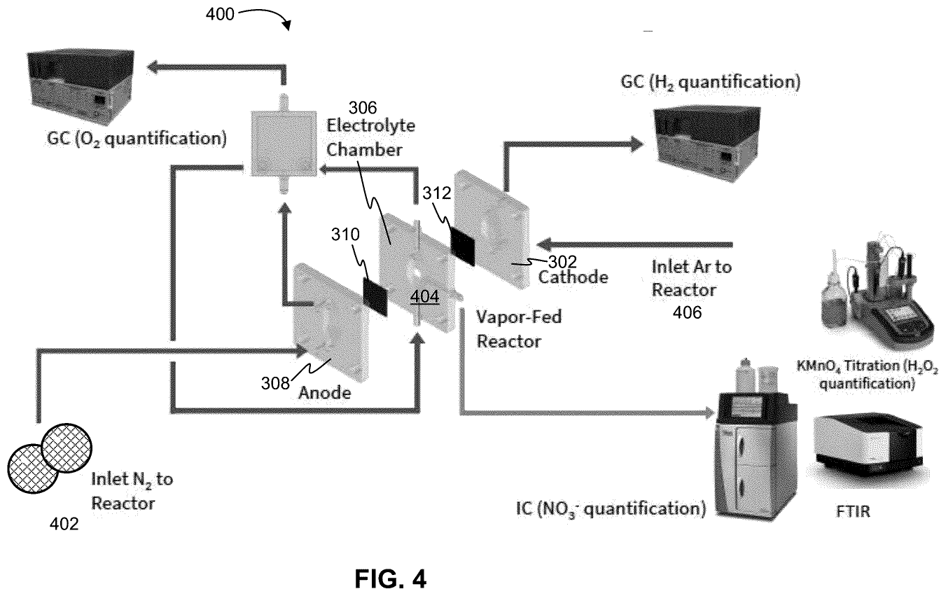

Referring now to FIG. 4, shows an operative view of the embodiment of an apparatus, systems, and methods shown in FIG. 3. According to one approach, the structural components of an advanced manufactured electrochemical reactor 400 include an anode gas compartment 308, an anode electrocatalyst 310, an electrolyte liquid compartment 306, a cathode gas compartment 302 and a cathode electrocatalyst 312.

A feed 402 may be fluidly connected to an inlet of the anode gas compartment 308. The feed may be any suitable feed compatible with the chemical reaction and the reactor. For example, one or more of the components of a suitable feed includes, but is not limited to, N₂, Air, CO₂, Ar, He, H₂, H₂O, O₂, and combinations thereof. The feed may have any suitable flow rate. For example, a suitable flow rate includes, but is not limited to, from about 0 standard cubic centimeters (sccm) to about 100 sccm, and range or value there between.

The anode geometric current density, or the amount of electric current flowing per unit of geometric surface area of the electrode, may be in a range from about 0.5 mA/cm² to 500 mA/cm², and any range or value there between. The cathode geometric current density may be in a range from about 0.5 mA/cm² to 500 mA/cm², and any range or value there between.

The electrolyte liquid compartment 306 includes an electrolyte 404 that is selected according to the feed gas and desired product. The electrolyte 404 may be fluidly connected to the electrolyte compartment 306. The electrolyte may be any suitable buffer. In a preferred approach, the electrolyte is a liquid compatible with the chemical reaction and the reactor. In preferred approaches, the electrolyte is carbonate and functions to activate the formation of nitrate from air, e.g., oxidizing nitrogen to produce nitrate, and to activate the reduction of nitrate to ammonia. In other approaches, the electrolyte may include electrolytes commonly used in electrochemical cells. In one approach, the electrolyte may include perchlorate. For example, a suitable electrolyte includes, but is not limited to, any KHCO₃ electrolyte, any H₂SO₄ electrolyte, any K₂SO₄ electrolyte, any KClO₄ electrolyte, any KOH electrolyte. The electrolyte may be present in a concentration in a range of 0.1 M to 1 M in water. The electrolyte may have any suitable flow rate. For example, a suitable flow rate includes, but is not limited to, from about 0 mL/min to about 100 mL/min, and range or value there between.

A conduit 406 may be connected to the cathode gas compartment 302 for flowing a sweep gas. The conduit 406 provides an inlet to connect the sweep gas (e.g., Ar, CO₂, etc.) to the cathode gas compartment 302 and the cathode electrocatalyst 312. The flowing gas may be any inert gas compatible to remove formed gas from the cathode. For example, a flowing gas stream may include, but is not limited to, Ar, air, CO₂, He, N₂, N₂O, and combinations thereof. The flowing gas stream may have any suitable flow rate. For example, a suitable rate of the flowing gas stream includes, but is not limited to, from about 0 standard cubic centimeters (sccm) to about 100 sccm, and range or value there between. In some approaches, the rate of flowing gas stream may be higher than 100 sccm.

The structure of the electrochemical reactor having a vapor-fed architecture may be used for different processes, e.g., H₂ production, NH₃ production, etc. The electrochemical reactor is designed to function to convert air with a nitrogen oxidation reaction (NOR) at the anode to form oxidation states of nitrogen intermediate products in liquid electrolyte, and then reducing the intermediate products in the liquid electrolyte at the cathode. In one approach, the reduction reaction at the cathode is a nitrate reduction reaction (NO₃RR) to form ammonia (NH₃). In another approach, an electrochemical reactor includes reacting air gas at the anode to make nitrate in the electrolyte, and then at the cathode water is split to form hydrogen (H₂).

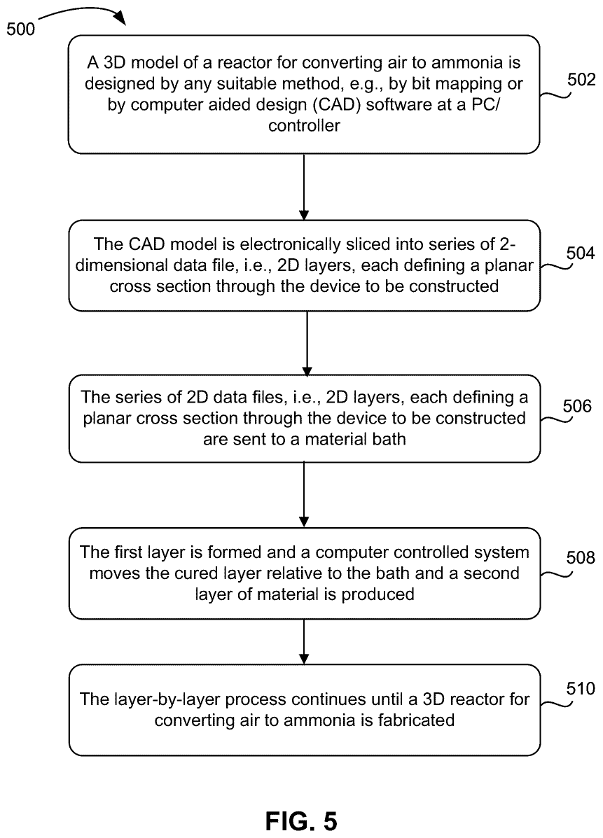

FIG. 5 shows a method 500 for forming a 3D electrochemical cell that converts air (N₂+O₂) to nitric acid (HNO₃) and ammonia (NH₃) by advanced manufacturing, in accordance with one aspect of one inventive concept. As an option, the present method 500 may be implemented to construct structures such as those shown in the other FIGS. described herein. Of course, however, this method 500 and others presented herein may be used to form structures for a wide variety of devices and/or purposes which may or may not be related to the illustrative embodiments listed herein. Further, the methods presented herein may be carried out in any desired environment. Moreover, more or less operations than those shown in FIG. 5 may be included in method 500, according to various embodiments. It should also be noted that any of the aforementioned features may be used in any of the embodiments described in accordance with the various methods.

Method 500 begins with operation 502 where a 3D model of a reactor for converting air to ammonia may be designed by any suitable method, e.g., by bit mapping or by computer aided design (CAD) software at a PC/controller. In some approaches, operations of an additive manufacturing system to fabricate a reactor for converting air to ammonia may be completed as described herein. There are a wide variety of additive manufacturing processes that can be used to create complicated assemblies. Examples include powder-bed laser printing systems, fused deposition modeling, and other process that involve producing complex assemblies.

Operation 504 includes the CAD model may be electronically sliced into a series of 2-dimensional (2D) data files, e.g., 2D layers, each defining a planar cross section through the device to be constructed.

Operation 506 includes sending the series of 2D data files, each defining a planar cross section through the device to be constructed, to a material bath.

Operation 508 includes forming the first layer where a computer controlled system moves the cured layer relative to the bath and a second layer of material is produced.

Operation 510 includes a layer-by-layer process that continues until a 3D reactor for converting air to ammonia is fabricated.

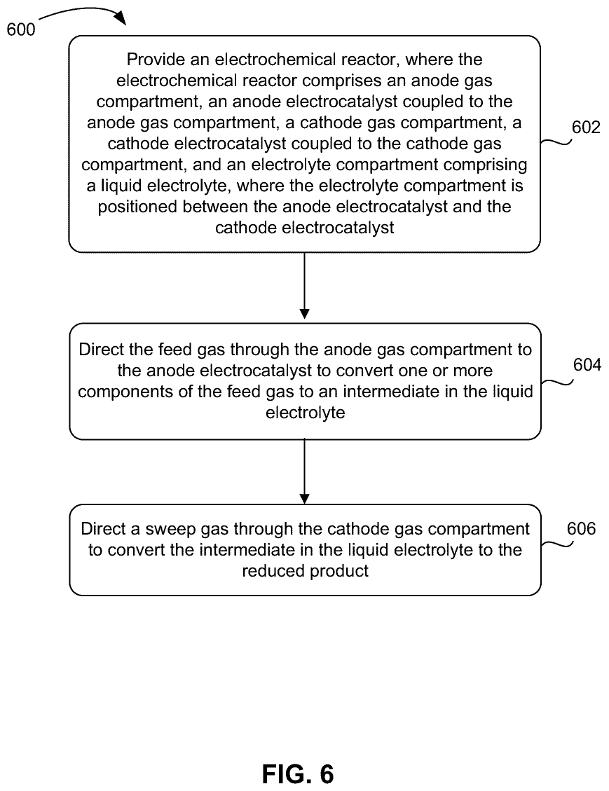

FIG. 6 shows a method 600 of converting a feed gas to a reduced product using an electrochemical reactor as described herein, in accordance with one aspect of one inventive concept. As an option, the present method 600 may be implemented to construct structures such as those shown in the other FIGS. described herein. Of course, however, this method 600 and others presented herein may be used to form structures for a wide variety of devices and/or purposes which may or may not be related to the illustrative embodiments listed herein. Further, the methods presented herein may be carried out in any desired environment. Moreover, more or less operations than those shown in FIG. 6 may be included in method 600, according to various embodiments. It should also be noted that any of the aforementioned features may be used in any of the embodiments described in accordance with the various methods.

Operation 602 of method 600 includes providing an electrochemical reactor, where the electrochemical reactor includes an anode gas compartment, an anode electrocatalyst coupled to the anode gas compartment, a cathode gas compartment, a cathode electrocatalyst coupled to the cathode gas compartment, and an electrolyte compartment that includes a liquid electrolyte, the electrolyte compartment positioned between the anode electrocatalyst and the cathode electrocatalyst. In various examples, the electrochemical reactor may be any one of the electrochemical reactors and systems illustrated in FIGS. 2-4.

Operation 604 includes directing the feed gas through the anode gas compartment to the anode electrocatalyst to convert one or more components of the feed gas to an intermediate in the liquid electrolyte. In various approaches, the feed gas may include: N₂, Air, CO₂, Ar, He, H₂, H₂O, O₂, or a combinations thereof. In preferred approaches, the feed gas includes N₂. In one exemplary approach, the feed gas is air and the reduced product is ammonia. Air is about 78% N₂ (and 21% O₂) plus impurities.

The temperature and pressure of the anode gas compartment may be ambient conditions. In one approach, the temperature may be about room temperature and the pressure is 1 ATM. The temperature and pressure of the electrochemical reactor may be at ambient conditions. For example, gases having a temperature of room temperature may enter the reactor via the anode gas compartment at about the same temperature (i.e., room temperature), and the reactions at the anode electrocatalyst, the electrolyte compartment, and at the cathode electrocatalyst proceed at about room temperature. In some approaches, the temperature may be increased up to 60° C.

Referring to pressure of the reactions in the reactor, there may not be an applied pressure in the reactor. For example, the feed gas may be at about ambient pressure, and the electrolyte compartment is not pressurized, vacated, etc. The reactions at the anode electrocatalyst, in the electrolyte compartment, and at the cathode electrocatalyst proceed at ambient pressure.

In an exemplary approach, the liquid electrolyte is a carbonate. In various approaches, various electrolytes may be included as a liquid electrolyte in the electrolyte compartment. Moreover, conditions of the electrolyte may be tailored for the oxidation reactions on the anode and reduction reactions on the cathode. In one approach the pH of the electrolyte may be considered. For example, across a range of pH, from a concentrated acid (H₂SO₄) to a concentrated basic solution (KOH) an increase in potential is detected. For example, the liquid electrolyte is potassium carbonate (K₂CO₃). In particular, at an application of about 2 V to the reactor, the reactor having a carbonate electrolyte demonstrates an increase in total current that is not demonstrated in reactors having other electrolytes in the spectrum of pH. Moreover, an increase in activity is detected in the reactor with flowing N₂ that is differentiated from the reactor in the absence of N₂. Flowing N₂ to the anode results in a higher total current in a reactor compared to input of flowing Ar to the anode and input of flowing CO₂ to the anode.

Operation 606 includes directing a sweep gas through the cathode gas compartment to convert the intermediate in the liquid electrolyte to the reduced product. In preferred approaches the sweep gas is an inert gas. In one approach, the sweep gas is argon gas (Ar).

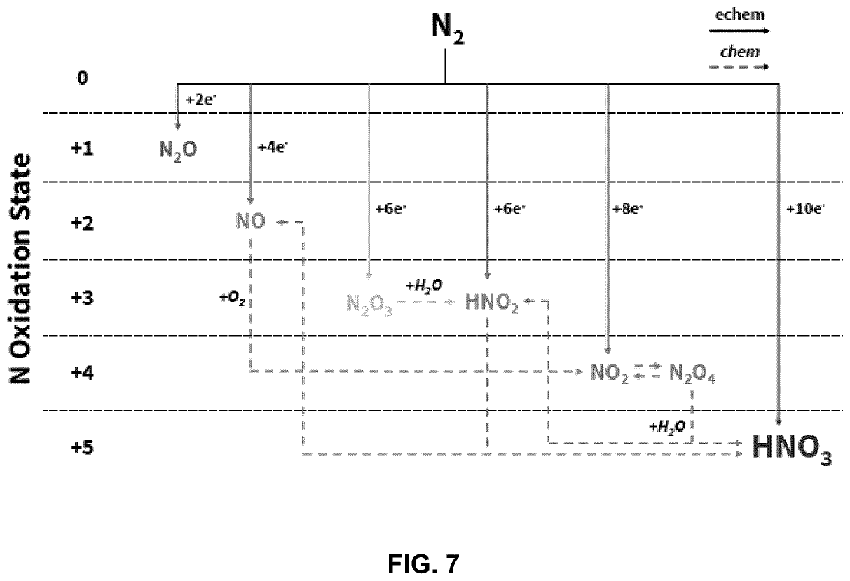

In various approaches, the anode, including the anode gas compartment and anode electrocatalyst, may have potential to form many nitrogen-based products from an N₂ activation and oxidation mechanism. FIG. 7 illustrates possible nitrogen-based products that may be formed at the anode by a nitrogen oxidation reaction (NOR). Without wishing to be bound by any theory, a combination of chemical and electrochemical steps may be involved within the anode compartment to form nitrate from nitrogen. There may be many different reactions possible to form nitrate, and these reactions may be happening at the same time or in sequence. For example, the nitrogen from air may be oxidized to NO, and NO reacts with oxygen on the anode to form NO₂, and then NO₂ in equilibrium with N₂O₄, N₂O₄ reacts with water to make nitrate and nitric acid, etc.

In various approaches, the NOR reaction may depend on selecting an appropriate starting catalyst and facet of the starting catalyst. For example, PtO₂ (100) provides favorable binding energies of the following nitrogen species listed in Table 1.

TABLE 1
Binding energies of Nitrogen
species on PtO₂ surface

| | |
|---|---|
| ΔG(N₂) | −0.22 eV |
| ΔG(N₂O) | −0.42 eV |
| ΔG(NO₂) | −1.31 eV |
| ΔG(NO) | −1.42 eV |

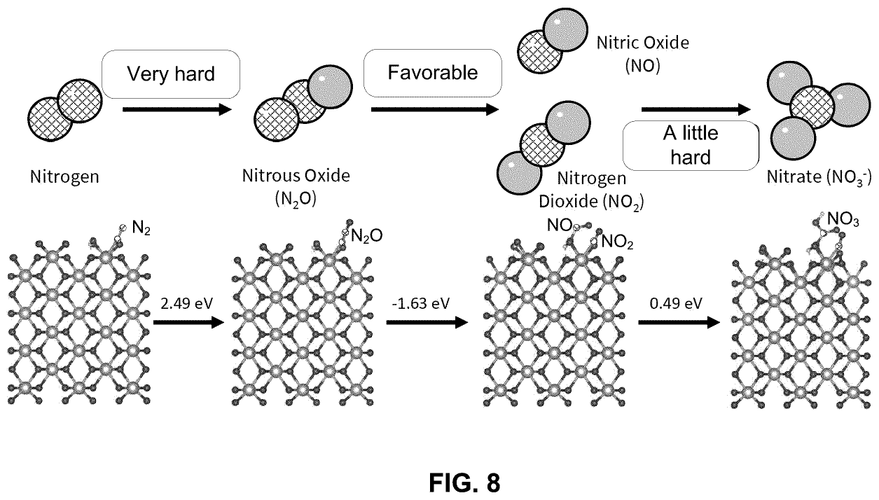

FIG. 8 illustrates one example of the rate limiting steps for NOR on an anode having a PtO₂ surface. The rate limiting step is the activation of the N₂ bond into N₂O on a PTO₂ surface, which is very hard having an E₀ of 2.49 eV. However, thereafter, breaking the N—O bond is favorable and forming a combination of NO and NO₂ with an E₀ of −1.63 eV. Formation of NO₃⁻ is then possible with an E₀ of 0.49 eV. In preferred approaches, a reactor may take advantage of the higher N₂ solubility as well as the higher gas diffusivity thereby allowing the reaction of activating the N₂ bond with a single oxygen.

### Experiments

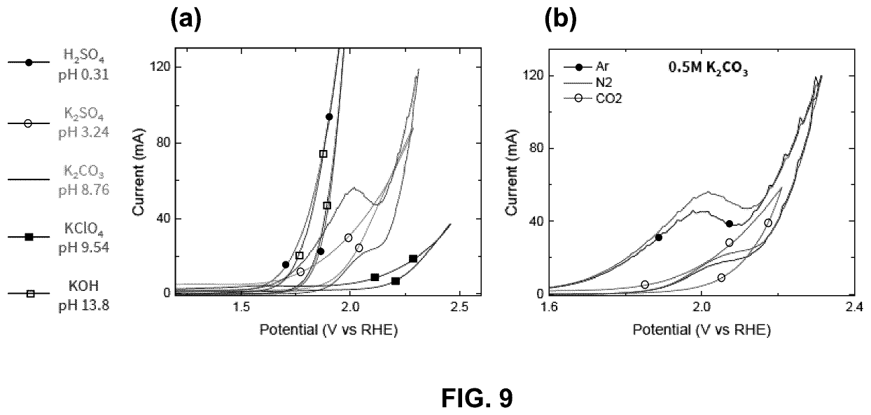

FIG. 9 illustrates the effect of different electrolytes on total current of the reactor. Part (a) is a plot of total current when air is the reactant in a reactor having an electrolyte of H₂SO₄ (pH 0.31) (●), K₂SO₄ (pH 3.24) (◯), K₂CO₃ (pH 8.76) (solid line), KClO₄ (pH 9.54) (▪), and KOH (pH 13.8) (□). Carbonate (solid line) demonstrates a peak at about 2 V (x-axis) which is distinct from the other electrolytes. Part (b) is a plot of total current of different input gases into the reactor having 0.5 M K₂CO₃ as the electrolyte. The input of N₂ (solid line) demonstrates a higher total current compared to the input of Ar (●) or CO₂ (◯). At about 2 V, the peak of total current is higher with N2 compared to Ar, and the peak disappears with the input of CO2.

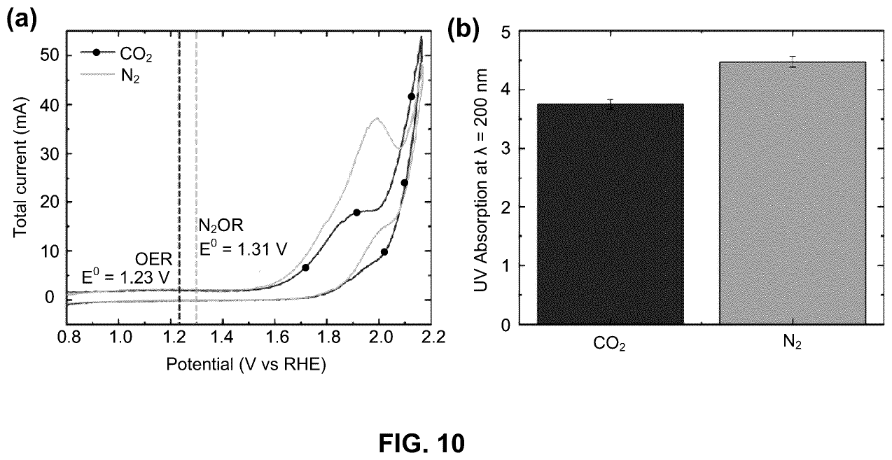

Referring now to parts (a) and (b) of FIG. 10, preliminary experiments demonstrate a significant increase in total current when air is the reactant gas compared to CO₂ (a) and about a 20% increase in UV light absorption (λ=200 nm) in the air sample (b). Both nitrate and bicarbonate absorb in this region (hence the initial signal in the CO₂ control sample); however, the increase in signal in the air sample suggests nitrate was produced.

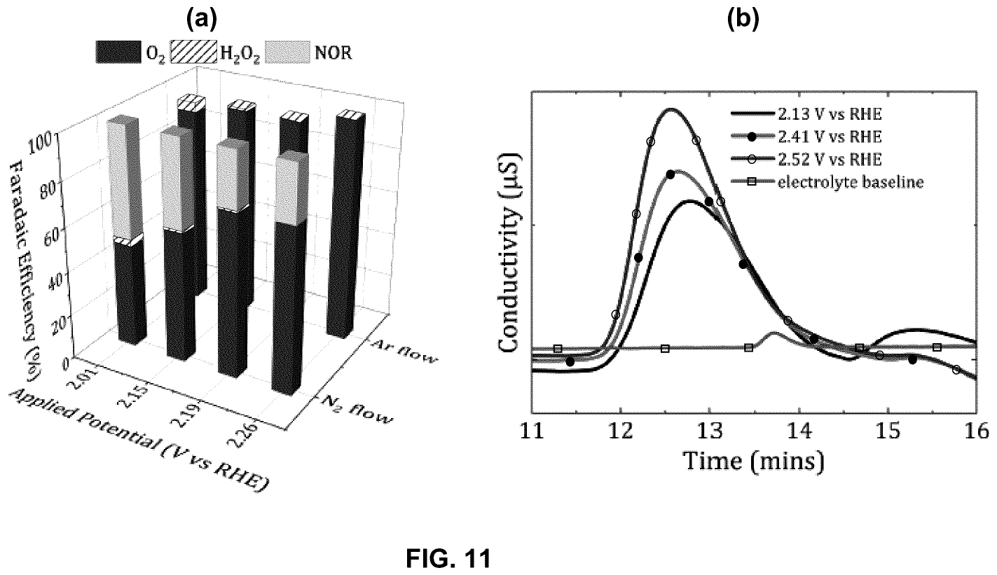

FIG. 11 depicts results of a reactor using 3 M carbonate electrolyte in a series of experiments (in triplicate) where the input gas at the anode is tested: first flow being Ar (as a control) and second flow being N₂ (as the test). Part (a) is a plot of assessing the application of four different potentials (2.01, 2.15, 2.19, and 2.26 V vs RHE) and measured current and faradaic efficiency. In the control in the absence of N₂, the row of Ar flow shows near 100% O₂. Moreover, some H₂O₂ is formed in addition to the O₂ reaction in the Ar flow. Switching to N₂ flow, where the only difference in the reactor is the change input gas from the flow of Ar to a flow of N₂, repressed amounts of O₂ are produced but also an indication that selectivity as a function of potential demonstrates that NOR is resulting in oxidized N₂.

Part (b) of FIG. 11 depicts a quantification of nitrate produced using ion chromatography at these different potentials. The nitrate produced at 2.13 V vs RHE (black line) up to the nitrate produced at 2.52 V vs RHE (o) is greater than the nitrate produced at baseline (u), which is indicated by the increase in conductivity due to the increased presence of the charged molecule NO₃.

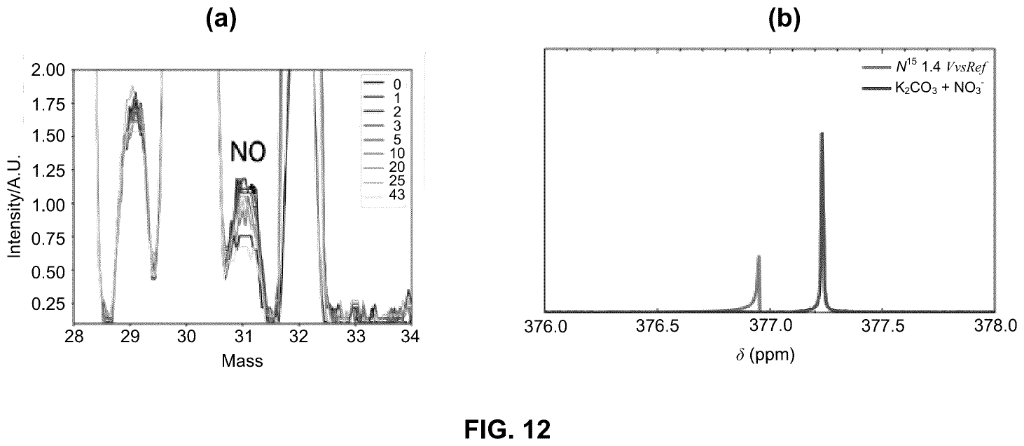

FIG. 12 depicts plots of mass spectrometry (part (a)) and nuclear magnetic resonance (NMR) (part (b)) of products formed at the anode in the reactor with flowing N₂ gas. Part (a) demonstrates that mass spectrometry detects ¹⁵NO as a product in the as phase when using ¹⁵N₂ gas. Part (b) demonstrates that ¹⁵N NMR detects ¹⁵NO₃⁻ as a product in the liquid phase (in K₂CO₃) when using ¹⁵N₂ gas.

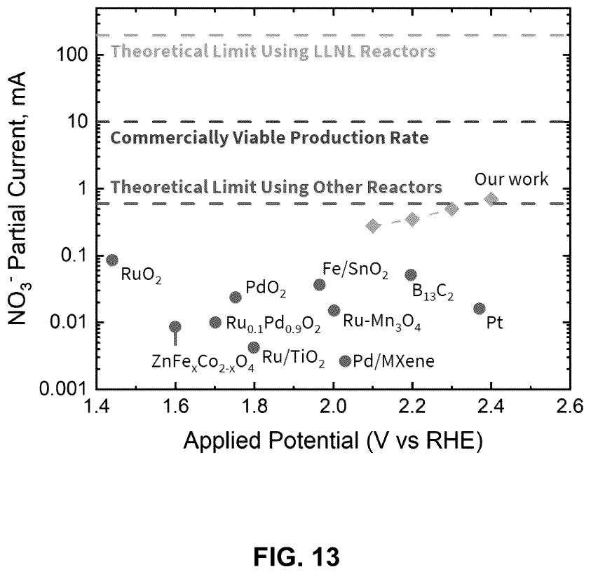

FIG. 13 depicts nitrate (NO₃⁻) production in terms of NO₃⁻ partial current versus applied potential. Everyone thinks this reaction doesn't happen, the reaction at the anode is limited to oxygen evolution. Prior reports of chemical reactions of NO₃⁻ partial current (●) are below the amounts of nitrate being produced at the anode in a reactor as described herein (♦). The prior reports (●) use an H-cell reactor that bubble N₂ in an electrolyte that require nitrogen diffusion in liquid water toward a catalyst and this severely limits the amount of nitrogen oxygenation since nitrogen is not soluble in water. In sharp contrast, the reactor described herein feeds gaseous N₂ (e.g., feeding air comprised of N₂) directly onto the anode having an electrocatalyst, allowing the reactor to produce nitrate in the electrolyte. Preliminary tests with air absorbance have shown detections of nitrate. The nitrate produced in the reactor as described herein has a promising application for commercially viable production rates.

Therefore, it will be appreciated that the scope of the present application fully encompasses other embodiments which may become obvious to those skilled in the art. In the claims, reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device to address each and every problem sought to be solved by the present apparatus, systems, and methods, for it to be encompassed by the present claims. Furthermore, no element or component in the present disclosure is intended to be dedicated to the public regardless of whether the element or component is explicitly recited in the claims. No claim element herein is to be construed under the provisions of 35 U.S.C. 112, sixth paragraph, unless the element is expressly recited using the phrase “means for.”

While the apparatus, systems, and methods may be susceptible to various modifications and alternative forms, specific embodiments have been shown by way of example in the drawings and have been described in detail herein. However, it should be understood that the application is not intended to be limited to the particular forms disclosed. Rather, the application is to cover all modifications, equivalents, and alternatives falling within the spirit and scope of the application as defined by the following appended claims.

### In Use

Various aspects of an inventive concept described herein may be developed for complementing and extending electrochemical gas technologies.

The inventive concepts disclosed herein have been presented by way of example to illustrate the myriad features thereof in a plurality of illustrative scenarios, aspects of an inventive concept, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While various aspects of an inventive concept have been described above, it should be understood that they have been presented by way of example only, and not limitation. Thus, the breadth and scope of an aspect of an inventive concept of the present invention should not be limited by any of the above-described exemplary aspects of an inventive concept, but should be defined only in accordance with the following claims and their equivalents.

What is claimed is:

1. An apparatus for converting air to ammonia, the apparatus comprising:
an anode gas compartment for receiving air;
an anode electrocatalyst coupled to the anode gas compartment;
a cathode gas compartment;
a cathode electrocatalyst coupled to the cathode gas compartment; and
an electrolyte compartment comprising a liquid electrolyte, wherein the electrolyte compartment is positioned between the anode electrocatalyst and the cathode electrocatalyst,
wherein the anode electrocatalyst is operably configured to convert nitrogen from the air to nitrate at the anode electrocatalyst,
wherein the cathode electrocatalyst is operably configured to convert the nitrate to the ammonia at the cathode electrocatalyst.

2. The apparatus for converting air to ammonia of claim 1, wherein the anode electrocatalyst is selected from the group of electrocatalysts consisting of: platinum (Pt), titanium (Ti), iridium (Ir), nickel (Ni), iron (Fe), ruthenium (Ru), palladium (Pd), tin (Sn), and gallium (Ga).

3. The apparatus for converting air to ammonia of claim 1, wherein the anode electrocatalyst includes an oxide and/or an alloy of one or more elements selected from the group consisting of: platinum (Pt), titanium (Ti), Iridium (Ir), Nickle (Ni), Iron (Fe), Ruthenium (Ru), Palladium (Pd), tin (Sn), gold (Au), silver (Ag), copper (Cu), cobalt (Co), and Gallium (Ga).

4. The apparatus for converting air to ammonia of claim 1, wherein the cathode electrocatalyst is selected from the group of electrocatalysts consisting of: silver (Ag), gold (Au), copper (Cu), platinum (Pt), titanium (Ti), iridium (Ir), nickel (Ni), Iron (Fe), and tin (Sn).

5. The apparatus for converting air to ammonia of claim 1 wherein the cathode electrocatalyst includes an oxide and/or alloy of one or more elements selected from the group consisting of: silver (Ag), gold ((Au), copper (Cu), platinum (Pt), titanium (Ti), iridium (Ir), nickel (Ni), Iron (Fe), and tin (Sn).

6. The apparatus for converting air to ammonia of claim 1, further comprising a silicon gasket positioned between at least two adjacent components of the apparatus.

7. The apparatus for converting air to ammonia of claim 1, wherein the anode gas compartment is open to the air.

8. The apparatus for converting air to ammonia of claim 1, comprising a conduit connected to the cathode gas compartment for flowing a sweep gas.

9. The apparatus for converting air to ammonia of claim 1, wherein the anode gas compartment is configured to flow air into the apparatus wherein a N₂ component of the air is configured to react at the anode electrocatalyst.

10. The apparatus for converting air to ammonia of claim 1, wherein the liquid electrolyte comprises a carbonate.

11. The apparatus for converting air to ammonia of claim 1, wherein the apparatus converts nitrogen and oxygen to nitrate and the ammonia.

12. The apparatus for converting air to ammonia of claim 11, further comprising a system for converting the ammonia and nitrate to fertilizers.

13. A method of converting a feed gas to a reduced product, comprising:
providing an electrochemical reactor, wherein the electrochemical reactor comprises:
an anode gas compartment,
an anode electrocatalyst coupled to the anode gas compartment,
a cathode gas compartment;
a cathode electrocatalyst coupled to the cathode gas compartment; and
an electrolyte compartment comprising a liquid electrolyte, wherein the electrolyte compartment is positioned between the anode electrocatalyst and the cathode electrocatalyst;
directing the feed gas through the anode gas compartment to the anode electrocatalyst to convert one or more components of the feed gas to an intermediate in the liquid electrolyte; and
directing a sweep gas through the cathode gas compartment to convert the intermediate in the liquid electrolyte to the reduced product.

14. The method of claim 13, wherein the anode electrocatalyst includes an electrocatalyst selected from a group consisting of: platinum (Pt), titanium (Ti), iridium (Ir), nickel (Ni), iron (Fe), ruthenium (Ru), palladium (Pd), tin (Sn), gold (Au), silver (Ag), copper (Cu), cobalt (Co), and gallium (Ga).

15. The method of claim 13, wherein the reactor operates on the gases at a temperature of about room temperature.

16. The method of claim 13, wherein the reactor operates on the gases at about ambient pressure.

17. The method of claim 13, wherein the feed gas is air, and the reduced product is ammonia.

18. The method of claim 13, wherein the one or more components of the feed gas are selected from the group consisting of: N₂, Air, CO₂, Ar, He, H₂, H₂O, O₂, and combinations thereof.

19. The method of claim 13, wherein the liquid electrolyte comprises a carbonate.

20. The method of claim 13, wherein the sweep gas is an inert gas.
